(19) United States
(12) Patent Application Publication
(10) Pub. No.: US 2006/0113881 A1
(43) Pub. Date: Jun. 1, 2006

(54) FLUSH MOUNTED OVERHEAD DISPLAY

(75) Inventors: Jeff Donovan, St. Clair Shores, MI (US); Miwa Okabayshi, Kawasaki (JP); Yuichi Murase, Kawasaki (JP); Katsutoshi Shimizu, Kawasaki (JP); Sumihisa Iwashita, Kawasaki (JP); Naoyuki Sawasaki, Kawasaki (JP)

Correspondence Address: JOHN A. ARTZ, ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 10/904,141

(22) Filed: Oct. 26, 2004

(51) Int. Cl. A47B 67/02; G06F 1/16; H04N 5/64

(52) U.S. Cl. 312/248; 361/681; 348/794

(57) ABSTRACT

An automotive entertainment assembly is provided including a vehicle roof and a headliner. The headliner provides a substantially uniform internal surface. A mounting frame assembly is positioned between the headliner and the vehicle roof. A circuit board is mounted to the mounting frame assembly. A multi-media display assembly is rotatably mounted to the mounting frame assembly and includes an upper panel edge, a lower panel edge, a pair of panel side edges. The display assembly is rotatable between a stored position and a deployed position. The multi-media display assembly includes a rear display panel surface substantially flush with the uniform internal surface when in the stored position A flexible cable provides communication between the circuit board and the multi-media display assembly.

### TECHNICAL FIELD

The present invention relates generally to an automotive overhead display system and more particularly to an overhead display system capable of storage substantially flush with an automotive headliner.

### BACKGROUND OF THE INVENTION

Automotive designs must be adaptable to accommodate an ever increasing range of convenience features. Vehicles have become vessels for entertainment, information dissemination, and family living. A central actor in this performance is the multi-media display. These displays are used to play movies, as child pacifiers, to display vehicle location, to provide directions, and even to access services such as the internet. The wide range of features that can be implemented using a video display has increased their presence in modern vehicle design.

Although the displays may be installed in a wide variety of locations throughout the vehicle, a popular location is to mount them on the vehicle roof, protruding downwards from the headliner just behind the forward seats. This is a convenient location as it provides a line of sight for passengers potentially all rows behind the front seats. Thus a single screen can serve a plurality of passengers. These displays commonly fold up for storage and to minimize interference with rear-view mirror line-of-sight. These screens additionally fold down for viewing.

An issue arising with present headliner positioned displays arises from the bulk commonly associated with the video screens and related electronic components. The resultant bulk from the panel and electronics commonly extrudes downward into the passenger compartment of the vehicle even when the screen is folded up for storage. This can generate interference with passenger headroom and may artificially constrain positioning of the display where optimal viewing would otherwise be achieved. Additionally, protrusion into the passenger compartment may generate interference in portions of the rear-view mirror viewing window. Although the level of interference may not be large, it may be sufficient to cause displeasure or mild distraction to the driver. This may negatively impact customer satisfaction.

It would therefore be highly desirable to have an automotive entertainment assembly with reduced profile when in the stored position. It would further be highly desirable to have such an automotive entertainment assembly that provided an outward appearance designed to improve customer satisfaction.

### SUMMARY OF THE INVENTION

It is therefore an object to the present invention to provide an automotive entertainment assembly with improved storage profile. It is further an object of the present invention to provide an automotive entertainment assembly with reduced footprint for increased customer satisfaction.

In accordance with the objects of the present invention an automotive entertainment assembly is provided including a vehicle roof and a headliner. The headliner provides a substantially uniform internal surface. A mounting frame assembly is positioned between the headliner and the vehicle roof. A circuit board is mounted to the mounting frame assembly. A multi-media display assembly is rotatably mounted to the mounting frame assembly and includes an upper panel edge, a lower panel edge, a pair of panel side edges. The display assembly is rotatable between a stored position and a deployed position. The multi-media display assembly includes a rear display panel surface substantially flush with the uniform internal surface when in the stored position A flexible cable provides communication between the circuit board and the multi-media display assembly.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of an automotive interior illustrating an automotive entertainment assembly in accordance with the present invention, the automotive entertainment assembly illustrated in the stored position.

FIG. 2 is an illustration of an automotive interior illustrating an automotive entertainment assembly in accordance with the present invention, the automotive entertainment assembly illustrated in the deployed position.

FIG. 3 is an illustration of the automotive entertainment assembly illustrated in FIG. 1.

FIG. 4 is a cross-sectional illustration of the automotive entertainment assembly illustrated in FIG. 1.

FIG. 5 is a cross-sectional illustration of the automotive entertainment assembly illustrated in FIG. 1, the cross-section illustrating the hinge section.

### DESCRIPTION OF PREFERRED EMBODIMENTS

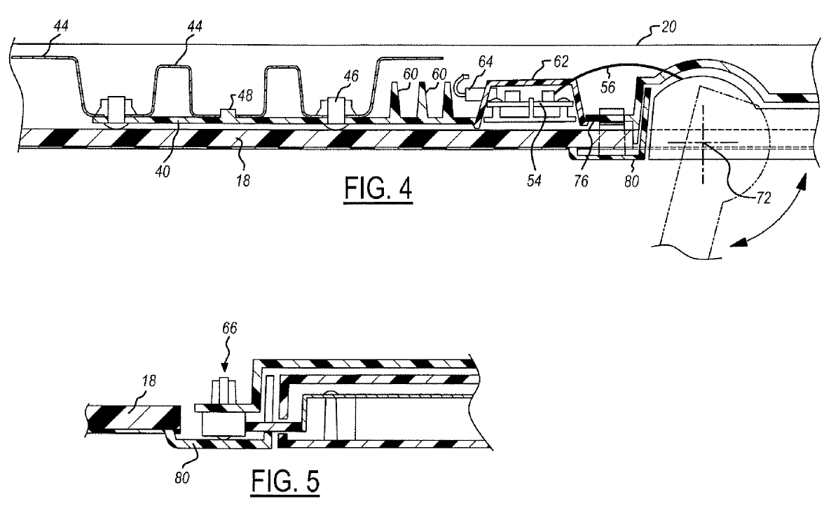

Referring now to FIG. 1, which is an illustration of an automotive entertainment assembly 10 in accordance with the present invention. The assembly 10 is illustrated installed within a vehicle 12 and illustrated from view within the passenger compartment 14. The present invention provides a novel approach to integration of the automotive entertainment assembly 10 into the passenger compartment 14 by minimizing intrusion of the entertainment assembly 10. The automotive entertainment assembly 10 includes a multi-media display assembly 16 mounted and positioned between the vehicle headliner 18 and the vehicle roof 20 (see FIG. 4).

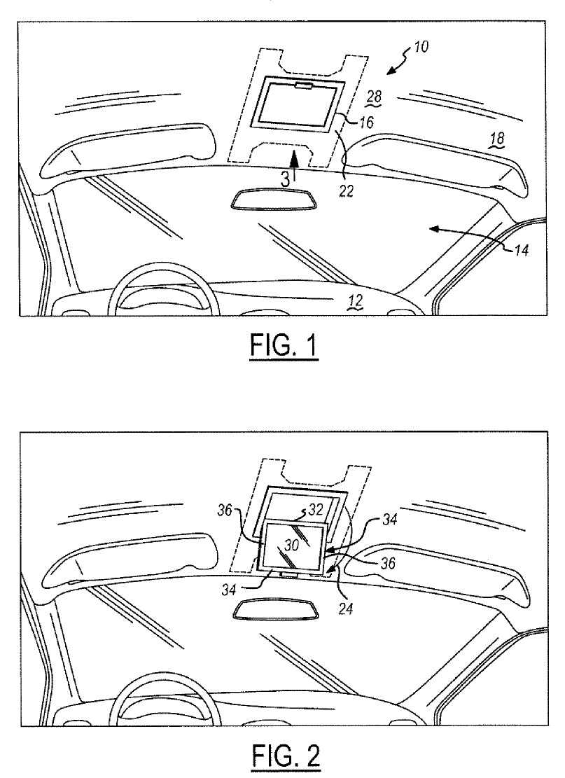

The multi-media display assembly 16 is rotatable between a stored position 22 and a deployed position 24 (see FIG. 2). In the stored position 22, the rear display panel surface 26 remains substantially flush with the internal surface 28 of the headliner 18. The internal surface 28 remains substantially uniform. By this it is meant that there are no large scale intrusions of the headliner 18 into the passenger compartment 14. The multi-media display assembly 16 therefore remains unobtrusive and flush with the headliner 18 when in the stored position 22. This is accomplished by positioning the multi-media display assembly 16 completely between the headliner 18 and the vehicle roof 22 when in the stored position 22. Although a variety of multi-media display assemblies 16 are contemplated, one common embodiment contemplates the use of a liquid crystal display panel (LCD). The LCD panel 30 is surrounded by a panel frame 31 having an upper panel edge 32, a lower panel edge 34 and a pair of panel side edges 36.

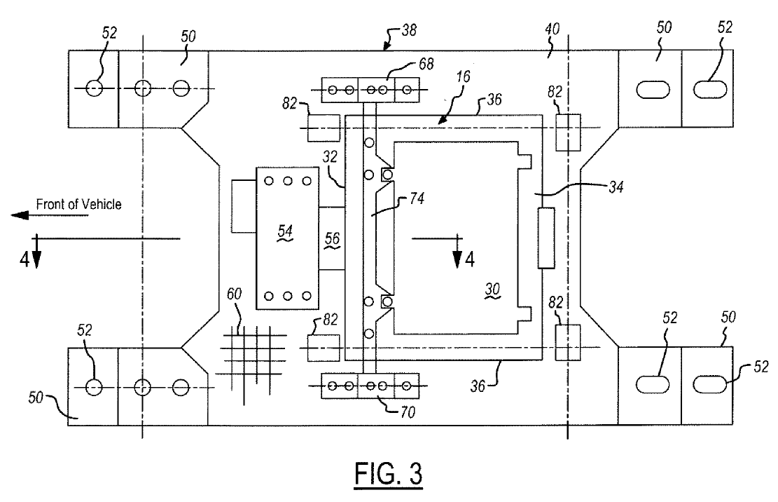

The multi-media display assembly 16 is secured between the headliner 18 and the vehicle roof 20 by way of a mounting frame assembly 38 (see FIG. 3). The mounting frame assembly 38 includes a polymer panel 40 positioned between the headliner 18 and the vehicle roof 20. The mounting frame assembly 38 may also include a stamped metal panel 42 including a plurality of roof flanges 44 for mounting to the vehicle roof 20. Although an independent metal panel 42 may be fabricated, it is contemplated that the metal panel 42 may simply be the headliner mounting panel existing in vehicles to allow for attachment of the headliner 18 to the roof 20. The polymer panel 40 may be affixed to the metal panel 42 in a variety of fashions such as through the use of attachment bolds 46 or other z-axis clips. Panel location elements 48 may be used to correctly position the polymer panel 40 to the metal panel 42. The very attachments used to affix the headliner 18 to the headliner mounting panel 42 may be also used as securing fasteners for the mounting frame assembly 38.

It is contemplated that the polymer panel 40 may include a plurality of extended mounting flanges 50 mounted to the perimeter of the polymer panel 40. These extended mounting flanges 50 are removable and include a plurality of additional mounting locations 52. This gives the polymer panel 40 design flexibility such that it may be installed in a wide variety of differing vehicle configurations and designs. A printed circuit board 54 is mounted to the polymer panel 40 and is placed in communication with the multi-media display assembly 16 by way of a flexible cable 56 such as a ribbon cable. This allows the display 16 to be reduced in dimensional width by moving the circuit board 54 out of direct contact with the LCD 30 or similar display element. By spreading the components out they can be easily fit between the headliner 18 and the vehicle roof 20.

It is contemplated that the circuit board 54 must be capable of withstanding a wide range of vehicle vibrations during operation. The present invention, therefore contemplates a plurality of stiffening ribs 60 formed into the polymer panel 40 in regions surrounding the circuit board 54. It is even contemplated that the circuit board 54 may be directly mounted to a select group of these stiffening ribs 60. In addition, a circuit board cover 62 may be mounted to the polymer panel 40 such that the circuit board 54 is positioned between the polymer panel 40 and the cover 62. This further reduces the chance for damage to the circuit board 54. A connector element 64 may extrude through the circuit board cover 62 to allow easy communication with the PCB 54.

The multimedia display assembly 16 is rotatably mounted to the mounting frame assembly 38 by way of at least one frictional hinge element 66. The at least one frictional hinge element 66 preferably comprises a right hinge element 68 and a left hinge element 70 mounted to provide a hinge rotation center line 72 remote from the upper panel edge 32 of the display assembly 16. This allows for the multi-media display assembly 16 to be rotated between positions with minimal interference from surrounding structure. It is further contemplated that a panel support bracket 74 is mounted connecting the left and right hinges elements 68,70 and the display panel 30 is directly mounted to the panel support bracket 74. This ensures a reduction is support structure (allowing further reduction in dimensions) as well as insuring proper rotational movement. Although friction hinges are preferred, a variety of hinge styles are contemplated by the present invention. Friction hinges assure the multi-media display assembly 16 may be stopped in any position allowed by the hinges 68,70 and remain there until further adjustment is imparted by vehicle passengers.

It is further contemplated that a cantilever stop arm 76 may be formed onto the multi-media display assembly 16 such that a precise stored position 22 may be consistently achieved. The assembly 10 may also include a trim panel 80 (or trim ring) which may be utilized to improve appearance and hide internal display mechanism from view. It is contemplated that the trim ring 80 may be mounted to the mounting frame assembly by way of a plurality of trim attachment guides 82 formed in the polymer panel 40. This allows a finished appearance to be installed into any vehicle regardless of configuration since only the mounting frame assembly 38 need be physically mounted to the vehicle and the attachments necessary to do so are hidden from view after installation.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An automotive entertainment assembly comprising:
a vehicle roof;
a headliner positioned below said vehicle roof, said headliner providing a substantially uniform internal surface; and
a multi-media display assembly movable between a stored position and a deployed position, said multi-media display assembly positioned between said vehicle roof and said headliner when in said stored position, said multi-media display assembly including a rear display panel surface substantially flush with said uniform internal surface when in said stored position.

2. An automotive entertainment assembly as described in claim 1, wherein said multi-media display assembly includes an upper panel edge, a lower panel edge, a pair of panel side edges, and a panel hinge, said panel hinge positioned distant from said upper panel edge.

3. An automotive entertainment assembly as described in claim 1, further comprising:
a mounting frame assembly positioned between said vehicle roof and said headliner;
a friction hinge positioned between said multi-media display assembly and said mounting frame assembly, said friction hinge allowing said multi-media display assembly to be rotated between said stored position and said deployed position.

4. An automotive entertainment assembly as described in claim 3, where said mounting frame assembly comprises:
a metal panel including a plurality of roof flanges extending towards said vehicle roof; and
a polymer panel mounted to a headliner side of said metal panel, said polymer panel including a plurality of stiffening ribs.

5. An automotive entertainment assembly as described in claim 4, further comprising:
a printed circuit board mounted to said polymer panel; and
a flexible cable placing said multi-media display assembly in communication with said printed circuit board.

6. An automotive entertainment assembly as described in claim 5, further comprising a circuit board cover mounted to said polymer panel, said printed circuit board positioned between said circuit board cover and said polymer panel.

7. An automotive entertainment assembly as described in claim 2, further comprising:
a right hinge element mounted to one of said panel side edges;
a left hinge element mounted to the other of said panel side edges;
a support bracket mounted to both said right hinge element and said left hinge element; and
an lcd panel mounted to said support bracket.

8. An automotive entertainment assembly as described in claim 1, further comprising:
a trim ring mounted to said headliner surrounding said multi-media display assembly in said stored position, said trim ring substantially flush with said headliner.

9. An automotive entertainment assembly comprising:
a vehicle roof;
a headliner positioned below said vehicle roof, said headliner providing a substantially uniform internal surface;
a mounting frame assembly positioned between said headliner and said vehicle roof;
a circuit board mounted to said mounting frame assembly;
a multi-media display assembly rotatably mounted to said mounting frame assembly including an upper panel edge, a lower panel edge, a pair of panel side edges, said multi-media display assembly rotatable between a stored position and a deployed position, said multi-media display assembly positioned completely between said vehicle roof and said headliner when in said stored position, said multi-media display assembly including a rear display panel surface substantially flush with said uniform internal surface when in said stored position; and
a flexible cable in communication with said circuit board and said multi-media display assembly.

10. An automotive entertainment assembly as described in claim 9, a cantilever stop arm mounted to said upper panel edge, said cantilever stop arm engaging said mounting frame assembly to stop motion of said mutli-media display assembly in said stored position.

11. An automotive entertainment assembly as described in claim 9, further comprising:
a friction hinge element rotatably attaching said multi-media display assembly to said mounting frame assembly, said friction hinge element positioned away from said upper panel edge.

12. An automotive entertainment assembly as described in claim 9, wherein said mounting frame assembly comprises:
a polymer panel mounted to a stamped headliner mounting panel, said polymer panel positioned in between said headliner and said stamped headliner mounting panel.

13. An automotive entertainment assembly as described in claim 12, further comprising:
a plurality of rib element formed into said polymer panel, said plurality of ribs facing said stamped headliner mounting panel.

14. An automotive entertainment assembly as described in claim 13, wherein said circuit board is mounted to said plurality of rib elements.

15. An automotive entertainment assembly as described in claim 9, wherein said mounting frame assembly comprises:
a plurality of extended mounting flanges, said extended mounting flanges removable from said mounting frame assembly such that said mounting frame assembly is adaptable to a plurality of mounting configurations.

16. An automotive entertainment assembly as described in claim 9, further comprising:
a trim ring surrounding said multi-media display assembly, said trim ring mounted to a plurality of trim attachment guides formed in said mounting frame assembly.

17. An automotive entertainment assembly as described in claim 9, further comprising:
a friction hinge element rotatably attaching said multi-media display assembly to said mounting frame assembly, said friction hinge element including a right hinge element and a left hinge element, said right hinge element mounted to one of said panel side edges, said left hinge element mounted to the other of said panel side edges;
a support bracket mounted to both said right hinge element and said left hinge element; and
a lcd panel mounted to said support bracket.

18. A method of installing an automotive entertainment assembly within a vehicle comprising:
attaching a mounting frame to a stamped headliner mounting panel such that said mounting frame is positioned between a vehicle roof and a headliner with a substantially uniform inner surface;
mounting a multi-media display assembly to said mounting frame such that said multi-media display assembly is rotatable between a stored position and a deployed position, said multi-media display assembly positioned completely between said vehicle roof and said headliner when in said stored position, said multi-media display assembly including a rear display panel surface substantially flush with said uniform internal surface when in said stored position;
mounting a circuit board onto said mounting frame; and
placing said circuit board into communication with said multi-media display assembly using a flexible circuit.

19. An method as described in claim 18, further comprising:
stiffening said mounting frame by forming a plurality of nylon stiffening ribs onto said mounting frame such that said plurality of nylon stiffening ribs face said stamped headliner mounting panel.

20. An method as described in claim 18, further comprising:
forming a plurality of extended mounting flanges onto said mounting frame; and
selectively removing said plurality of extended mounting flanges to adapt said mounting frame to fit said stamped headliner mounting panel.
